(19) United States
(12) Patent Application Publication
(10) Pub. No.: US 2022/0066463 A1
(43) Pub. Date: Mar. 3, 2022

(54) MOBILE ROBOT AND METHOD OF CONTROLLING THE MOBILE ROBOT

(71) Applicant: LG ELECTRONICS INC., Seoul (KR)

(72) Inventor: Jaejung BYUN, Seoul (KR)

(73) Assignee: LG ELECTRONICS INC., Seoul (KR)

(21) Appl. No.: 17/309,880

(22) PCT Filed: Dec. 26, 2019
(86) PCT No.: PCT/KR2019/018469

§ 371 Date: Jun. 25, 2021

(30) Foreign Application Priority Data
Dec. 26, 2018 (KR) 10-2018-0169082

(51) Int. Cl. G05D 1/02; G06K 9/00; G06K 9/62

(52) U.S. Cl. CPC G05D 1/0234; G06K 9/00664; G06K 9/6215; G06K 9/6267; G05D 2201/0215; G05D 1/0274; G05D 1/0246; G05D 1/0214; G05D 1/0244

(57) ABSTRACT

Provided is a mobile robot including a driving unit for moving a main body; an image acquisition unit for obtaining an image of a periphery; and a controller for analyzing the image obtained by the image acquisition unit and determining whether a reflector exists in the vicinity of the main body, wherein the controller determines whether a reflector exists in the vicinity of the main body based on similarity between the image obtained by the image acquisition unit and the pre-stored image of the main body.

### BACKGROUND OF THE DISCLOSURE

### Field of the Disclosure

The present disclosure relates to a mobile robot, and more particularly, to a mobile robot capable of distinguishing a reflector.

### Background

Robots have been developed for industrial use and have been a part of factory automation. Recently, the field of application of robots has been further expanded, and medical robots and aerospace robots have been developed, and household robots that can be used in general households are also being made. Among these robots, those capable of driving by their own force are called mobile robots. A representative example of a mobile robot used at home is a robot cleaner.

Various technologies for detecting an environment and user around the robot cleaner through various sensors provided in the robot cleaner are known. Further, there are known technologies in which a robot cleaner learns and maps a driving area by itself, and determines a current location on a map. There has been known a robot cleaner that cleans a driving area while driving in a preset manner.

Conventional robot cleaners have identified distances and mapping between obstacles and walls in a peripheral environment thereof through an optical sensor that makes it easy to determine distances, identify topography, and recognize images of obstacles.

Further, in the prior art (Korea Patent Laid-Open Publication No. 10-2014-0138555), predetermined pattern light is radiated, an image of an area radiated with different light is obtained, and the pattern is detected to identify whether an obstacle exists in the vicinity of the cleaner.

However, although obstacle identification using the optical sensor is accurate, in the case of a mirror that reflects light, and furniture and home appliances having a metallic appearance, because it reflects light or a light pattern, there is a problem that a surface of the obstacle is not detected.

Therefore, the conventional robot cleaner does not avoid the reflector, collides, and has various problems such as damage or malfunction thereof.

### SUMMARY

The present disclosure provides a mobile robot capable of identifying a reflector while accurately identifying a surface shape and location of an obstacle using an optical sensor.

The present disclosure further provides a mobile robot capable of quick cleaning and avoidance when cleaning around the reflector in the future by identifying a reflector using an optical sensor and by processing an obstacle on a map.

In order to solve the above problems, when an image obtained by the mobile robot is analyzed, if an image of the mobile robot is viewed, the present disclosure determines the image as a reflector.

In an aspect, a mobile robot includes a driving unit for moving a main body; an image acquisition unit for obtaining an image of a periphery; and a controller for analyzing the image obtained by the image acquisition unit and determining whether a reflector is located in the vicinity of the main body, wherein the controller determines whether a reflector exists in the vicinity of the main body based on similarity between the image obtained by the image acquisition unit and a pre-stored image of the main body.

When similarity between the image obtained by the image acquisition unit and the pre-stored image of the main body exceeds a reference value, the controller may determine that a reflector exists in the vicinity of the main body.

When the controller determines that a reflector exists in the vicinity of the main body, the controller may specify a reflector area in which the reflector is located on a map of a driving area based on the obtained image.

The controller may control the driving unit so that the main body drives while avoiding the reflector area.

When the controller determines that the reflector exists in front of the main body while the main body is driving, the controller may control the driving unit to stop.

When the controller determines that the reflector exists in front of the main body while the main body is driving, the controller may control the driving unit to reduce a speed of the main body.

The controller may calculate a distance between the reflector and the main body based on a size of an image of the main body in the obtained image.

The mobile robot may further include an obstacle detection sensor for detecting an obstacle in front of the main body, wherein the controller may determine that a reflector exists in front of the main body when similarity between a front image obtained by the image acquisition unit and the pre-stored image of the main body exceeds a reference value and no obstacle is detected in front of the main body.

When similarity between the front image obtained by the image acquisition unit and the pre-stored image of the main body exceeds a reference value, and an obstacle is detected in front of the main body, the controller may determine that another mobile robot exists in front of the main body.

In another aspect, a method of controlling a mobile robot includes obtaining a front image of the mobile robot; analyzing the obtained image; comparing the analyzed image with a pre-stored image of the mobile robot; and determining whether a reflector exists based on a comparison result between the analyzed image and the pre-stored image of the mobile robot.

The determining of whether a reflector exists may include determining whether a reflector exists in front of the mobile robot based on similarity between the image obtained by the image acquisition unit and the pre-stored image of the mobile robot.

The determining of whether a reflector exists may include determining that a reflector exists in front of the mobile robot when similarity between the image obtained by the image acquisition unit and the pre-stored image of the mobile robot exceeds a reference value.

The method may further include specifying a reflector area in which the reflector is located on a map of the driving area based on the obtained image.

The method may further include avoidance driving step in which the mobile robot drives while avoiding the reflector area.

The method may further include detecting an obstacle in front of the mobile robot; and classifying the reflector and the obstacle based on whether an obstacle exists in front of the mobile robot.

Advantageous EffectsAccording to a mobile robot of the present disclosure, there are one or more of the following effects.

First, there is an advantage that a reflector can be identified while accurately identifying a surface shape and a location of an obstacle using an optical sensor.

Second, because an obstacle including a reflector can be identified with only an optical sensor without adding another sensor such as an ultrasonic sensor, there is an advantage that a production cost is reduced and the control burden of a mobile robot is reduced.

Third, because the mobile robot can accurately identify the reflector, the risk of collision of the mobile robot with the reflector is eliminated, and there is an advantage in preventing the reflector from being damaged.

Fourth, because the mobile robot identifies and avoids the reflector and first cleans an area except for a peripheral area of the reflector, the mobile robot uses an optical sensor that can be cleaned quickly, thereby accurately identifying a surface shape and location of the obstacle.

The effects of the present disclosure are not limited to the above-mentioned effects, and other effects not mentioned will be clearly understood by those skilled in the art from the description of the claims.

### BRIEF DESCRIPTION OF THE DRAWINGS

FIG. 1 is a perspective view illustrating a robot cleaner 100 and a charging stand 200 for charging the robot cleaner according to an embodiment of the present disclosure.

FIG. 2 is an elevation view illustrating the robot cleaner 100 of FIG. 1 viewed from above.

FIG. 3 is an elevation view illustrating the robot cleaner 100 of FIG. 1 viewed from the front.

FIG. 4 is an elevation view illustrating the robot cleaner 100 of FIG. 1 viewed from the lower side.

FIG. 5 is a block diagram illustrating a control relationship between main components of the robot cleaner 100 of FIG. 1.

FIG. 6 is a flowchart illustrating a method of controlling a robot cleaner according to an embodiment of the present disclosure.

FIG. 7 is a diagram illustrating a state in which a mobile robot approaches a reflector during a process performed according to the control method of FIG. 6.

FIG. 8 is a flowchart illustrating a method of controlling a robot cleaner according to another embodiment of the present disclosure.

### DETAILED DESCRIPTION

In the size comparison expressed linguistically/mathematically throughout this description, ‘less than or equal to (or less)’ and ‘less than’ are degrees that can be easily substituted for each other from the standpoint of those skilled in the art, and ‘greater than or equal to (or more)’ and ‘greater than (exceed)’ are degrees that can be easily substituted for each other from the standpoint of those skilled in the art, and even if it is substituted in implementing the present disclosure, there is no problem in exhibiting the effect.

A mobile robot 100, which is the present disclosure means a robot capable of moving by itself using wheels, etc., and may be a home helper robot, a robot cleaner, or the like.

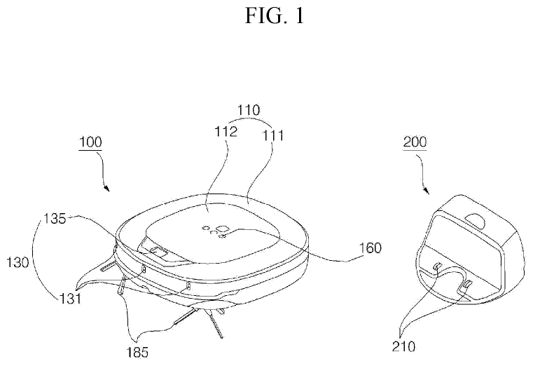

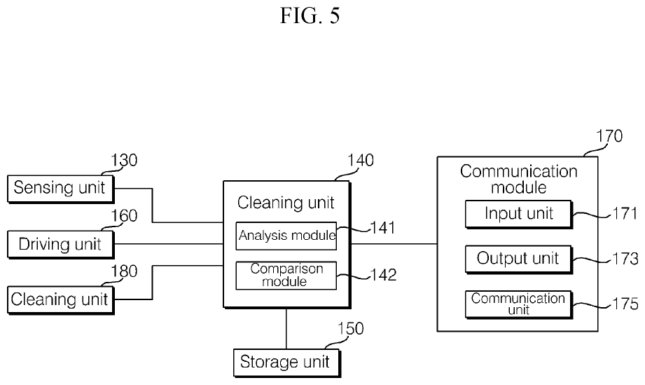

Hereinafter, the robot cleaner 100 among mobile robots will be described as an example with reference to FIGS. 1 to 5, but the present disclosure is not necessarily limited thereto.

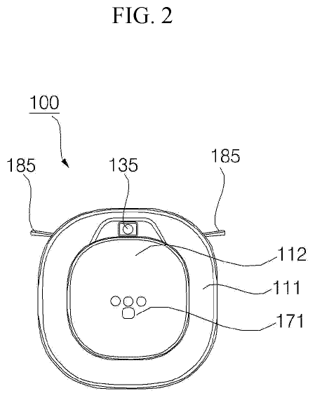

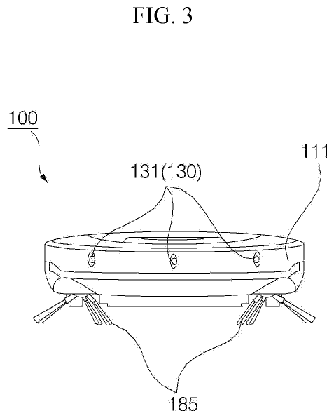

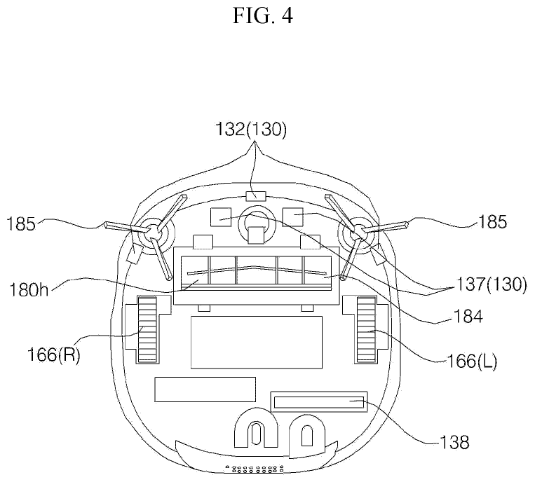

The robot cleaner 100 includes a main body 110. Hereinafter, in defining each part of the main body 110, a portion facing the ceiling in a driving area is defined as an upper portion (see FIG. 2), a portion facing the floor in a driving area is defined as a bottom portion (see FIG. 4), and a portion facing a driving direction among portions forming the circumference of the main body 110 between the upper portion and the bottom portion is defined as a front portion (see FIG. 3). Further, a portion facing in a direction opposite to the front portion of the main body 110 may be defined as a rear portion. The main body 110 may include a case 111 that forms a space in which various parts constituting the robot cleaner 100 are received.

The robot cleaner 100 includes a sensing unit 130 that detects a peripheral situation. The sensing unit 130 may detect external information of the robot cleaner 100. The sensing unit 130 detects obstacles in the vicinity of the robot cleaner 100. The sensing unit 130 may detect an object in the vicinity of the robot cleaner 100.

The sensing unit 130 may detect information on the driving area. The sensing unit 130 may detect obstacles such as walls, furniture, and cliffs on a driving surface. The sensing unit 130 may detect information on the ceiling. The sensing unit 130 may include an object placed on the driving surface and/or an external upper object. The external upper object may include a ceiling or a lower surface of furniture disposed in an upper direction of the robot cleaner 100. Through information detected by the sensing unit 130, the robot cleaner 100 may map the driving area.

The sensing unit 130 may detect information on obstacles in the vicinity of the robot cleaner 100. The sensing unit 130 may detect location information of the obstacle. The location information may include direction information on the robot cleaner 100. The location information may include distance information between the robot cleaner 100 and the obstacle. The sensing unit 130 may detect a direction of the obstacle with respect to the robot cleaner 100. The sensing unit 130 may detect a distance between the obstacle and the robot cleaner 100.

The location information may be obtained directly by detection of the sensing unit 130 or may be obtained by processing of a controller 140.

The driving area may be mapped through detection by the sensing unit 130, and location information of obstacles and reflectors may be detected on the map. Distance information may be measured as a distance between any two points on the map. The location of the robot cleaner 100 and the obstacle may be recognized on the map, and distance information between the robot cleaner 100 and the obstacle may be obtained using the coordinate difference on the map.

The location information of the obstacle and the reflector may be obtained through an image obtained by a camera or the like. An image may be obtained through an image acquisition unit 135.

The sensing unit 130 may include an image acquisition unit 135 that detects an image of the periphery. The image acquisition unit 135 may detect an image in a specific direction of the robot cleaner 100. For example, the image acquisition unit 135 may detect an image in front of the robot cleaner 100.

The image acquisition unit 135 captures the driving area and may include a digital camera. The digital camera may include at least one optical lens and an image sensor (e.g., complementary metal-oxide semiconductor (CMOS) image sensor) including a plurality of photodiodes (e.g., pixels) that are imaged by light passing through the optical lens, and a digital signal processor (DSP) that configures an image based on signals output from the photodiodes. The digital signal processor may generate a still image and a moving picture configured with frames configured with still images.

The sensing unit 130 may include a distance detection unit 131 that detects a distance to a peripheral obstacle. A distance between the robot cleaner 100 and the peripheral user may be detected through the distance detection unit 131. The distance detection unit 131 detects a distance to an obstacle in a specific direction of the robot cleaner 100. The distance detection unit 131 may include a camera, an ultrasonic sensor, or an infrared (IR) sensor.

The distance detection unit 131 may be disposed in a front portion of the main body 110 or may be disposed in a side portion thereof. Preferably, the distance detection unit 131 and the image acquiring unit 135 may be implemented into a single camera. In this case, a production cost of the robot cleaner may be reduced.

The sensing unit 130 may include a cliff detection unit 132 that detects whether a cliff exists in the floor within the driving area. A plurality of cliff detection units 132 may be provided.

The sensing unit 130 may further include a lower image sensor 137 that obtains an image of the floor.

The robot cleaner 100 includes a driving unit 160 that moves the main body 110. The driving unit 160 moves the main body 110 with respect to the floor. The driving unit 160 may include at least one driving wheel 166 for moving the main body 110. The driving unit 160 may include a driving motor. The driving wheels 166 may be provided at each of the left and right sides of the main body 110 and hereinafter, the driving wheels 166 may be referred to as a left wheel 166 (L) and a right wheel 166 (R), respectively.

The left wheel 166 (L) and the right wheel 166 (R) may be driven by one driving motor, but if necessary, a left wheel driving motor for driving the left wheel 166 (L) and a right wheel driving motor for driving the right wheel 166 (R), respectively may be provided. The driving direction of the main body 110 may be changed to the left or the right by making a difference in rotational speeds of the left wheel 166 (L) and the right wheel 166 (R).

The robot cleaner 100 includes a cleaning unit 180 that performs a cleaning function.

The robot cleaner 100 may move the driving area and clean the floor by the cleaning unit 180. The cleaning unit 180 may include a suction device for sucking foreign substances, brushes 184 and 185 for sweeping, a dust bin (not illustrated) for storing foreign substances collected by the suction device or brush, and/or a mop part (not illustrated) for mopping.

A suction port 180h in which air is sucked may be formed at the bottom of the main body 110. In the main body 110, a suction device (not illustrated) that provides a suction force so that air may be sucked through the suction port 180h, and a dust bin (not illustrated) that collects dust sucked together with air through the suction port 180h may be provided.

The case 111 may have an opening for insertion and removal of the dust bin, and a dust bin cover 112 for opening and closing the opening may be rotatably provided with respect to the case 111.

A roll type main brush 184 having brushes exposed through the suction port 180h, and an auxiliary brush 185 located at the front side of the bottom surface of the main body 110 and having a brush configured with a plurality of radially extended wings may be provided. Dust from the floor in the driving area is removed by the rotation of these brushes 184 and 185, and the dust separated from the floor is sucked through the suction port 180h and collected in the dust bin.

A battery 138 may supply power required for an overall operation of the robot cleaner 100 as well as the driving motor. When the battery 138 is discharged, the robot cleaner 100 may perform driving that returns to a charging stand 200 for charging, and during such return driving, the robot cleaner 100 may self-detect a location of the charging stand 200.

The charging stand 200 may include a signal transmitter (not illustrated) for transmitting a predetermined return signal. The return signal may be an ultrasonic signal or an infrared signal, but it is not necessarily limited thereto.

The robot cleaner 100 includes a communication module 170 that receives information. The communication module 170 may output or transmit information. The communication module 170 may include a communication unit 175 that transmits and receives information with other external devices. The communication module 170 may include an input unit 171 for inputting information. The communication module 170 may include an output unit 173 for outputting information.

For example, the robot cleaner 100 may receive information directly from the input unit 171. As another example, the robot cleaner 100 may receive information input to a separate terminal through the communication unit 175.

For example, the robot cleaner 100 may directly output information to the output unit 173. As another example, the robot cleaner 100 may transmit information to a separate terminal through the communication unit 175 so that the terminal outputs the information.

The communication unit 175 may be provided to communicate with an external server, the terminal, and/or the charging stand 200. The communication unit 175 may include a signal detection unit (not illustrated) for receiving a return signal. The charging stand 200 may transmit an infrared signal through the signal transmitter, and the signal detection unit may include an infrared sensor for detecting the infrared signal. The robot cleaner 100 moves to a location of the charging stand 200 according to the infrared signal transmitted from the charging stand 200 and docks with the charging stand 200. By such docking, charging is performed between a charging terminal 133 of the robot cleaner 100 and a charging terminal 210 of the charging stand 200.

The communication unit 175 may receive various command signals from the terminal. The communication unit 175 may receive information input from a terminal such as a smartphone or a computer.

The communication unit 175 may transmit information to be output to the terminal. The terminal may output information received from the communication unit 175.

The input unit 171 may receive On/Off or various commands. The input unit 171 may include a button, a key, or a touch type display. The input unit 171 may include a microphone for voice recognition.

The output unit 173 may notify a user of various types of information. The output unit 173 may include a speaker and/or a display.

The robot cleaner 100 includes a controller 140 that processes and determines various types of information, such as mapping and/or recognizing a current location. The controller 140 may control the overall operation of the robot cleaner 100 by controlling various components constituting the robot cleaner 100. The controller 140 may be provided to map a driving area through an image and to recognize a current location on the map. That is, the controller 140 may perform a simultaneous localization and mapping (SLAM) function.

The controller 140 may receive and process information from the communication module 170. The controller 140 may receive and process information from the input unit 171. The controller 140 may receive and process information from the communication unit 175. The controller 140 may receive and process information from the sensing unit 130.

The controller 140 may provide information to the communication module 170 for output. The controller 140 may provide information to the communication unit 175. The controller 140 may control the output of the output unit 173. The controller 140 may control the driving of the driving unit 160. The controller 140 may control an operation of the cleaning unit 180.

The robot cleaner 100 includes a storage unit 150 for storing various data. The storage unit 150 records various types of information necessary for controlling the robot cleaner 100, and may include a volatile or non-volatile recording medium.

The storage unit 150 may store a map for the driving area. The map may be input by an external terminal capable of exchanging information through the robot cleaner 100 and the communication unit 175, or may be generated by the robot cleaner 100 by self-learning. In the former case, examples of the external terminal may include a remote controller, a personal digital assistant (PDA), a laptop computer, a smart phone, and a tablet device equipped with an application for setting a map.

A real driving area may correspond to the driving area on the map. The driving area may be defined as a range including all areas on a plane in which the robot cleaner 100 has a driving experience and an area on a plane in which the robot cleaner 100 is currently driving.

The storage unit 150 may store a comparison target image to be compared with the image obtained by the controller 140 from the image acquisition unit 135. The comparison target image may be directly input by the user, may be downloaded from a server connected to the robot cleaner, or may be accumulated by learning.

The controller 140 may determine a movement path of the robot cleaner 100 based on the operation of the driving unit 160. For example, the controller 140 may determine a current or past moving speed, a driven distance, and the like of the robot cleaner 100 based on a rotation speed of the driving wheel 166, and also determine a current or past direction change process according to the rotation direction of each driving wheel 166 (L) and 166 (R). Based on the driving information of the robot cleaner 100 determined in this way, the location of the robot cleaner 100 on the map may be updated. Further, the location of the robot cleaner 100 may be updated on the map using the image information.

The controller 140 recognizes locations of the obstacle and the reflector based on the information detected through the sensing unit 130. The controller 140 may obtain information on the location of peripheral obstacles and reflectors through the sensing unit 130. The controller 140 may obtain distance information to peripheral obstacles and reflectors through the sensing unit 130.

For example, the controller 140 may calculate a distance between the reflector and the main body based on the size of the image of the main body (robot cleaner) in the image obtained by the image acquisition unit 135. Specifically, the controller 140 may extract an outline or an external shape of the main body, calculate a size of a width and/or height of the external shape, and calculate a distance between the reflector and the robot cleaner using a perspective method.

The controller 140 controls to follow the user and clean. The controller 140 may control the driving unit 160 so that the robot cleaner 100 follows the user movement. The controller 140 may control the cleaning unit 180 so that the robot cleaner 100 cleans a peripheral area of the user. The controller 140 may control to follow the user's movement to clean the peripheral area of the user.

The controller 140 may control the movement of the robot cleaner 100 based on the distance detected by the sensing unit 130. The controller 140 may determine whether to follow the user movement based on the distance to the user detected by the distance sensor 131. When the distance is relatively large, the controller 140 may determine that the user movement is followed, and when the distance is relatively small, the controller 140 may determine that the user movement is not followed. When the distance is greater than (or exceeds) a predetermined value, the controller 140 may control the robot cleaner 100 to follow the user movement. When the distance is less than a predetermined value (or less), the controller 140 may control the robot cleaner 100 to clean a peripheral area of the user.

Further, the controller 140 may analyze the image obtained by the image acquisition unit 135 to determine whether a reflector exists around the main body. For example, the controller 140 may include an analysis module 141 that analyzes the image obtained by the image acquisition unit 135 and a comparison module 142 that compares the image analyzed by the analysis module 141 with a reference image.

The controller 140 may determine whether a reflector exists in the vicinity of the main body based on similarity between the image obtained by the image acquisition unit 135 and a pre-stored image of the main body.

The controller 140 first analyzes the image obtained through the image acquisition unit 135. Specifically, the controller 140 extracts an external shape and color information of the obtained image based on learned data or data already stored, and determine a type of an object in the obtained image based on the extracted external shape information and color information.

When it is determined that the object in the obtained image is a robot cleaner, the controller 140 may compare similarity between the stored image of the main body (itself) and the obtained image. When similarity between the image obtained by the image acquisition unit and the pre-stored image of the main body exceeds a reference value, the controller 140 may determine that a reflector exists in the vicinity of the main body.

Here, similarity refers to a correlation between a previously stored front image of oneself and an image obtained through the image acquisition unit 135 by being reflected by the reflector. The controller 140 may determine similarity in appearance or color between a previously stored front image of itself and an image obtained through the image acquisition unit 135 by being reflected by the reflector. The controller 140 may determine similarity in appearance or color between the previously stored front image of itself and an inverted image obtained by reversing the left and right sides of the obtained image.

In order to determine accurate similarity, when the controller 140 determines that the obtained image is an image of the robot cleaner itself, the controller 140 controls the driving unit 160 so that the robot cleaner moves slowly, and in this case, when there is a change in the size of the obtained image, the controller 140 may determine that the reflector exists in front of the robot cleaner.

Further, the robot cleaner needs to distinguish an obstacle and a reflector on a map to be viewed to the user. Accordingly, the present disclosure may further include an obstacle detection sensor for detecting an obstacle in front of the main body. The obstacle detection sensor may include a distance detection unit 131 using any one of an optical sensor (IR sensor) and a camera.

When similarity between an image in one direction obtained by the image acquisition unit 135 and the pre-stored image of the main body exceeds a reference value, and no obstacle is detected in one direction of the main body, the controller 140 may determine that the reflector exists in one direction of the main body.

Specifically, when similarity between the front image obtained by the image acquisition unit 135 and the pre-stored image of the main body exceeds a reference value and no obstacle is detected in front of the main body, the controller 140 may determine that a reflector exists in front of the main body.

Further, when similarity between an image in one direction obtained by the image acquisition unit 135 and the pre-stored image of the main body exceeds a reference value, and an obstacle is detected in one direction of the main body, the controller 140 may determine that another mobile robot exists in the one direction of the main body.

Specifically, when similarity between the front image obtained by the image acquisition unit 135 and the pre-stored image of the main body exceeds a reference value and an obstacle is detected in front of the main body, the controller 140 may determine that another robot exists in front of the main body.

In this case, when the other mobile robot moves, the controller 140 may drive along the driving path as it is, and when the other mobile robot is in a stationary state, the controller 140 may drive while avoiding the other mobile robot.

When the controller 140 determines that the reflector exists in the vicinity of the main body, the controller 140 may specify a reflector area in which the reflector is located on the map of the driving area based on the obtained image. Preferably, the controller 140 may analyze the image obtained by the image acquisition unit 135 to calculate a size and direction of the reflector. In the direction in which the reflector is detected, the controller 140 calculates the distance to the reflector as the size of the obtained image, and specifies the distance and direction (location information of the reflector) of the reflector.

Further, in order to specify a width of the reflector, the controller 140 may obtain an image while driving slowly around the reflector, and specify distance information and direction information between the reflector and the main body in another direction or another location with the obtained image. The controller 140 may specify a reflector area on the map based on the obtained location information of the reflector, as described above.

When the reflector is detected, the controller 140 may control the driving unit so that the main body may drive while avoiding the reflector area. Specifically, when the reflector is detected, the controller 140 may control the driving unit to drive along the boundary of the reflector or to drive except for the reflector area.

Further, in order to prevent the main body from being damaged, when it is determined that a reflector exists in front of the main body while the main body is driving, the controller 140 may control the driving unit to stop. When the robot cleaner recognizes the reflector, the controller 140 stops once to prevent the reflector and the robot cleaner from being damaged, and enables the robot cleaner to obtain a computation time.

Further, when the controller 140 determines that the reflector exists in front of the main body while the main body is driving, the controller 140 may control the driving unit to reduce a speed of the main body. While the main body is moving slowly, the controller 140 may obtain an image of the reflector while driving around an area in which the reflector is determined to exist, and collect accurate location information of the reflector.

When the robot cleaner recognizes the reflector, the robot cleaner drives slowly to prevent the reflector and the robot cleaner from being damaged, enables to obtain a computation time thereof, and facilitates collection of reflector location information.

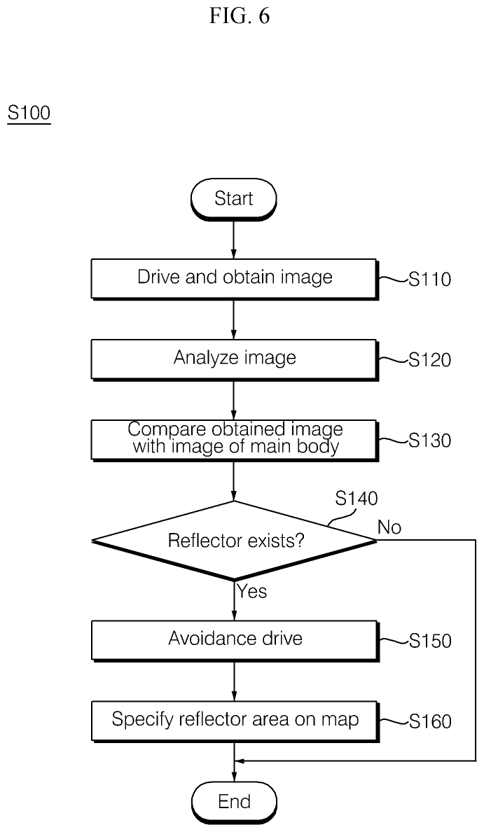

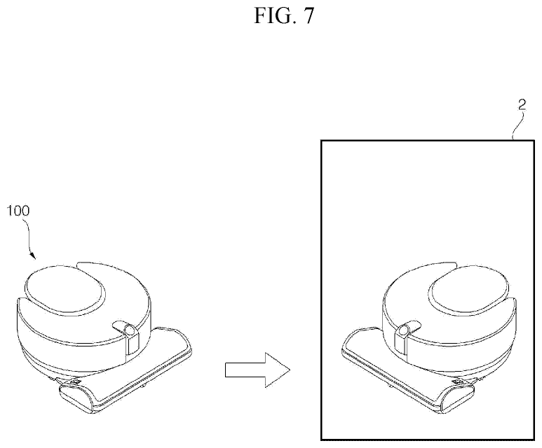

FIG. 6 is a flowchart illustrating a method of controlling a robot cleaner according to an embodiment of the present disclosure, and FIG. 7 is a diagram illustrating a state in which a mobile robot approaches a reflector during a process performed according to the control method of FIG. 6.

Referring to FIGS. 6 and 7, a method of controlling the robot cleaner 100 according to embodiments of the present disclosure will be described. In each of the flowcharts, overlapping contents are denoted by the same reference numerals, and overlapping descriptions will be omitted.

The control method may be performed by the controller 140. The present disclosure may be a method of controlling the robot cleaner 100 or may be a robot cleaner 100 including the controller 140 for performing the control method. The present disclosure may be a computer program including each step of the control method, or a recording medium on which a program for implementing the control method in a computer is recorded. The ‘recording medium’ means a computer readable recording medium. The present disclosure may be a robot cleaner control system including both hardware and software.

Each step of flowcharts of the control method and combinations of the flowcharts may be performed by computer program instructions. The instructions may be mounted on a general purpose computer, a special purpose computer, or the like, and the instructions generate a means for performing functions described in step(s) of the flowchart.

Further, in some embodiments, functions recited in the steps may occur out of order. For example, two steps illustrated one after another may be performed substantially simultaneously, or the steps may sometimes be performed in the reverse order according to the corresponding function.

A method of controlling a mobile robot (S100) according to an embodiment of the present disclosure may include image acquisition step (S110) of obtaining a peripheral image of the mobile robot, analysis step (S120) of analyzing the obtained image, comparison step (S130) of comparing the analyzed image with an image of a pre-stored mobile robot, and reflector determination step (S140) of determining whether a reflector exists based on a comparison result between the analyzed image and the pre-stored image of the mobile robot.

In the image acquisition step, the robot cleaner obtains an image of the mobile robot in real time while driving. The controller 140 may control the image acquisition unit 135 to obtain a peripheral image of the robot cleaner at regular intervals while driving. Here, the peripheral image of the robot cleaner may include front and side surfaces of the robot cleaner.

In the analysis step, the robot cleaner analyzes the obtained image. Specifically, the controller 140 extracts an appearance and color information of the obtained image based on learned data or data already stored, and determines a type of an object in the obtained image based on the extracted appearance information and color information.

In the comparison step, the robot cleaner compares the analyzed image with a pre-stored image of the mobile robot. Here, the pre-stored image of the mobile robot means an image of the robot cleaner itself. The controller 140 determines based on similarity between the image obtained by the image acquisition unit and the pre-stored image of the main body.

In the reflector determination step, the robot cleaner determines whether the reflector exists based on a comparison result between the analyzed image and the pre-stored image of the mobile robot. In the reflector determination step, the robot cleaner may determine whether a reflector exists in the vicinity of the mobile robot based on similarity between the image obtained by the image acquisition unit and the pre-stored image of the mobile robot.

In the reflector determination step, when similarity between the image obtained by the image acquisition unit and the pre-stored image of the mobile robot exceeds a reference value, the robot cleaner determines that the reflector exists in the vicinity of the mobile robot.

The present disclosure may further include avoidance driving step (S150) in which the mobile robot drives while avoiding a reflector area. In the avoidance driving step, when the robot cleaner determines that the reflector exists in the vicinity thereof, the robot cleaner may specify a reflector area in which the reflector is located on the map of the driving area based on the obtained image. Preferably, the controller 140 may analyze the image obtained by the image acquisition unit 135 to calculate a size and direction of the reflector.

In the avoidance driving step, when the reflector exists within a predetermined distance in the front, the robot cleaner may stop driving, specify a reflector area, and drive while avoiding the reflector area.

The present disclosure may further include reflector area specifying step (S160) of specifying a reflector area in which the reflector is located on the map of the driving area based on the obtained image. In the reflector area specifying step, the robot cleaner may specify the reflector area in which the reflector is located on the map of the driving area based on the obtained image.

Specifically, the controller 140 may store map information in which the reflector area is specified in the storage unit. Further, the controller 140 may transmit map information in which the reflector area is specified to a server or to another robot cleaner.

Further, the present disclosure may further include obstacle detecting step of detecting an obstacle in the vicinity of the mobile robot and classification step of classifying the reflector and the obstacle based on whether an obstacle exists in the vicinity of the mobile robot.

In the obstacle detecting step, the robot cleaner controls the distance detection unit 131 to detect an obstacle in a direction in which the reflector is detected. In the step of distinguishing the reflector from the obstacle, when the distance is measured or distance information is input by the distance detection unit 131, the robot cleaner determines that an obstacle exists in the vicinity thereof, and when the distance information is not input, the robot cleaner determines that a reflector exists in the vicinity of the robot cleaner.

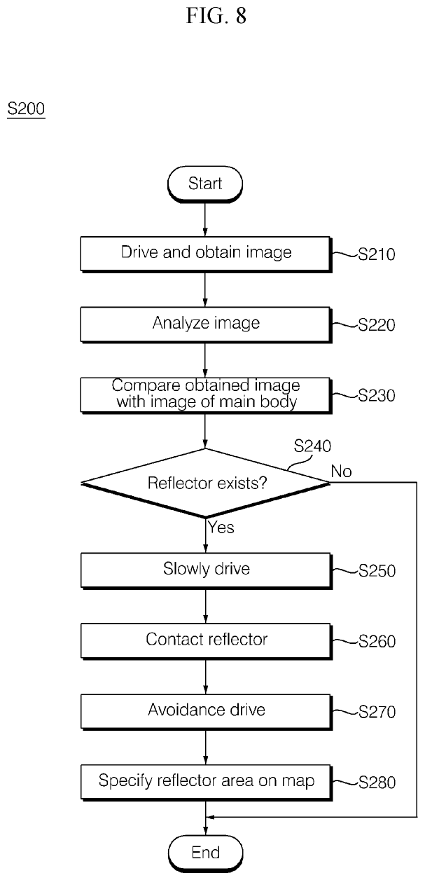

FIG. 8 is a flowchart illustrating a method of controlling a robot cleaner according to another embodiment of the present disclosure.

Compared with the embodiment of FIG. 7, the method of controlling the robot cleaner of FIG. 8 may further include slow driving step (S250) and step (S260) of contacting the reflector.

Referring to FIG. 8, in the slow driving step, when a reflector exists in the vicinity of the robot cleaner, the robot cleaner may drive slowly. Specifically, when it is determined that the obtained image is an image of the robot cleaner itself, the controller 140 may control the driving unit 160 so that the robot cleaner moves slowly. Here, the slow driving means that the robot cleaner drives at a speed lower than a preset speed.

When the robot cleaner drives slowly in the vicinity of the reflector and fails to collect accurate location information of the reflector, even if the reflector and the robot cleaner collide, the reflector and the robot cleaner may be prevented from being damaged. Further, while the robot cleaner drives slowly in the vicinity of the reflector, the robot cleaner can accurately collect location information of the reflector.

In step of contacting the reflector, the robot cleaner drives slowly in a direction of the reflector, stops when it comes into contact with the reflector, and then changes a direction thereof and drives. In step of contacting the reflector, by changing a size of the obtained image, the robot cleaner may calculate a distance between the robot cleaner and the reflector.

Because the robot cleaner can determine an accurate outer shape of the reflector while making contact with the reflector and an outer surface thereof, the robot cleaner can accurately collect location information of the reflector. This can compensate that when the robot cleaner uses an optical sensor, location information collection of the reflector has low accuracy with only an image.

In the above description, preferred embodiments of the present disclosure have been illustrated and described, but the present disclosure is not limited to specific embodiments described above, and various modifications may be made by those of ordinary skill in the art to which the present disclosure pertains without departing from the gist of the present disclosure as claimed in the claims, and these modifications should not be individually understood from the technical spirit or perspective of the present disclosure.

What is claimed is:

1. A mobile robot, comprising:
a driving unit for moving a main body;
an image acquisition unit for obtaining an image of a periphery; and
a controller for analyzing the image obtained by the image acquisition unit and determining whether a reflector exists in the vicinity of the main body,
wherein the controller determines whether a reflector exists in the vicinity of the main body based on similarity between the image obtained by the image acquisition unit and a pre-stored image of the main body.

2. The mobile robot of claim 1, wherein, when similarity between the image obtained by the image acquisition unit and the pre-stored image of the main body exceeds a reference value, the controller determines that a reflector exists in the vicinity of the main body.

3. The mobile robot of claim 1, wherein, when the controller determines that a reflector exists in the vicinity of the main body, the controller specifies a reflector area in which the reflector is located on a map of a driving area based on the obtained image.

4. The mobile robot of claim 1, wherein the controller controls the driving unit so that the main body drives while avoiding the reflector area.

5. The mobile robot of claim 1, wherein, when the controller determines that the reflector exists in front of the main body while the main body is driving, the controller controls the driving unit to stop.

6. The mobile robot of claim 1, wherein, when the controller determines that the reflector exists in front of the main body while the main body is driving, the controller controls the driving unit to reduce a speed of the main body.

7. The mobile robot of claim 1, wherein the controller calculates a distance between the reflector and the main body based on a size of an image of the main body in the obtained image.

8. The mobile robot of claim 1, further comprising an obstacle detection sensor for detecting an obstacle in front of the main body,
wherein, when similarity between a front image obtained by the image acquisition unit and the pre-stored image of the main body exceeds a reference value and no obstacle is detected in front of the main body, the controller determines that a reflector exists in front of the main body.

9. The mobile robot of claim 8, wherein, when similarity between the front image obtained by the image acquisition unit and the pre-stored image of the main body exceeds a reference value, and an obstacle is detected in front of the main body, the controller determines that another mobile robot exists in front of the main body.

10. A method of controlling a mobile robot, the method comprising:
obtaining an image of a periphery of the mobile robot;
analyzing the obtained image;
comparing the analyzed image with a pre-stored image of the mobile robot; and
determining whether a reflector exists based on a comparison result between the analyzed image and the pre-stored image of the mobile robot.

11. The method of claim 10, wherein the determining of whether a reflector exists comprises determining whether a reflector exists in the vicinity of the mobile robot based on similarity between the image obtained by the image acquisition unit and the pre-stored image of the mobile robot.

12. The method of claim 10, wherein the determining of whether a reflector exists comprises determining that a reflector exists in the vicinity of the mobile robot when similarity between the image obtained by the image acquisition unit and the pre-stored image of the mobile robot exceeds a reference value.

13. The method of claim 12, further comprising specifying a reflector area in which the reflector is located on a map of a driving area based on the obtained image.

14. The method of claim 13, further comprising avoidance driving step in which the mobile robot drives while avoiding the reflector area.

15. The method of claim 10, further comprising:
detecting an obstacle in the vicinity of the mobile robot; and
classifying the reflector and the obstacle based on whether an obstacle exists in the vicinity of the mobile robot.
